(19) United States
(12) Patent Application Publication
(10) Pub. No.: US 2026/0130542 A1
(43) Pub. Date: May 14, 2026

(54) AUTOMATIC GRILLING ROBOT

(71) Applicant: BEYOND HONEYCOMB INC., Seoul (KR)

(72) Inventors: Hyun Ki JUNG, Seoul (KR); Youn Seong KIM, Yongin-si (KR)

(21) Appl. No.: 19/317,832

(22) Filed: Sep. 3, 2025

(30) Foreign Application Priority Data
Nov. 11, 2024 (KR) 10-2024-0159574

(51) Int. Cl. A47J 36/32; A47J 36/38; A47J 37/04; B25J 11/00; F24C 15/20; G01N 21/55

(52) U.S. Cl. CPC A47J 36/32; A47J 36/38; A47J 37/041; A47J 37/049; B25J 11/0045; F24C 15/20; G01N 21/55

(57) ABSTRACT

An automatic grilling robot is provided. The automatic grilling robot includes a heat source, a driving unit, a sensing unit, and a control unit. The driving unit is configured to selectively position a grill on top of the heat source. The grill is configured to contain an ingredient. The sensing unit is configured to emit light to the ingredient and detect spectroscopic characteristics of light that is reflected from the ingredient. A control unit is configured to determine a cooking state of the ingredient based on the detected spectroscopic characteristics and control the driving unit based on the determined cooking state.

### CROSS-REFERENCE TO RELATED APPLICATION

The present application claims priority to Korean Patent Application No. 10-2024-0159574, filed on Nov. 11, 2024, in the Korean Intellectual Property Office, the entire disclosure of which is incorporated herein by reference.

### BACKGROUND

### 1. Field

Aspects of embodiments of the present disclosure relate to an automatic grilling robot, and more particularly, to an automatic grilling robot configured to maintain cooking quality to be uniform at a professional cook level by accurately detecting a cooking state during a grilling process.

### 2. Description of the Related Art

Generally, a grilling device is a cooking appliance that includes a container for holding food and a heating unit for applying heat to ingredients and is operated in a manner that allows a user to visually inspect and manually flip the food during a cooking process.

A technology capable of consistently maintaining uniform cooking results is required since this manual method increases fatigue for an operator and results in inconsistent cooking quality depending on individuals/users.

In recent grilling automation technologies, most systems adopted approaches such as rotating heated containers (drum type), robotic arm-based cooking devices, or griddle-type automated robots that follow fixed cooking patterns.

However, conventional drum-type cookers are primarily used for a mass production and struggle to ensure uniformity across ingredients. Robotic arm-based systems are costly and space-intensive. Griddle-type robots, on the other hand, fail to adjust cooking based on the state of ingredients and rely solely on preset patterns.

One related prior art is Korean Patent No. 10-1880865, which discloses a rotating drum-type gas oven.

The above information disclosed in this Background section is for enhancement of understanding of the background of the present disclosure, and therefore, it may contain information that does not constitute prior art.

### SUMMARY

According to one or more embodiments of the present disclosure, an automatic grilling robot includes: a heat source configured to generate heat; a driving unit configured to selectively position a grill on top of the heat source, the grill containing an ingredient; a sensing unit configured to emit light to the ingredient and detect spectroscopic characteristics of light that is reflected from the ingredient; and a control unit configured to determine a cooking state of the ingredient based on the detected spectroscopic characteristics and control the driving unit based on the determined cooking state.

In an embodiment, the driving unit may be configured to rotate the grill to invert the ingredient.

In an embodiment, the driving unit may include: a first housing; at least one link member comprising a rear end rotatably coupled to the first housing; and at least one first operating motor comprising a first drive shaft protruding from the first housing, the first drive shaft being mechanically connected to the at least one link member to transmit a rotational force.

In an embodiment, the driving unit may further include: a second housing coupled to a front end of the link member, the second housing comprising a front end to which a rear end of the grill is rotatably coupled; and a second operating motor comprising a second drive shaft protruding from the second housing, the second drive shaft being mechanically connected to the rear end of the grill to transmit a rotational force.

In an embodiment, the automatic grilling robot may further include a screen having an installation space that is open downward. The sensing unit may be provided in the installation space and configured to emit light downward.

In an embodiment, the automatic grilling robot may further include an exhaust port formed at one side of the screen to define a ventilation path between the installation space and an outer area; and a ventilation unit placed in the screen to discharge internal air in the screen from the installation space to the outer area through the exhaust port.

In an embodiment, the control unit may be configured to analyze the spectroscopic characteristics to determine the cooking state of the ingredient.

In an embodiment, molecular information of the ingredient may be detected based on the spectroscopic characteristics. The molecular information may be used by the control unit to control the driving unit.

In an embodiment, the molecular information may include at least one of a moisture amount, a protein/fact/collagen composition ratio, ripeness, a Maillard reaction level, or a tissue-characteristic change of the food ingredient.

In an embodiment, the control unit may be further configured to operate the driving unit with a cooking pattern that matches with the detected cooking state of the ingredient.

According to one or more embodiments of the present disclosure, an automatic grilling robot includes: a driving unit configured to selectively position a grill on top of a heat source, the grill containing an ingredient; a control unit configured to determine a cooking state of the ingredient and control the driving unit to cook the ingredient based on the determined cooking state; a manipulation unit electrically connected to the control unit, the manipulation unit configured to allow a user to operate the control unit to cook the ingredient; and a display unit configured to display various types of information about cooking of the ingredient.

In an embodiment, the various types of information may include at least one of a cooking time, a cooking intensity, or molecular information of the ingredient.

In an embodiment, the control unit may be further configured to display the cooking state of the ingredient to the user.

In an embodiment, the driving unit may be further configured to rotate the grill to invert the ingredient.

In an embodiment, the driving unit may be further configured to move the grill up or down in a vertical direction.

According to one or more embodiments of the present disclosure, a method of automatically cooking an ingredient includes: generating, by a heat source, heat; selectively positioning, by a driving unit, a grill on top of the heat source, the grill containing the ingredient; emitting, by a sensing unit, light to the ingredient; detecting, by the sensing unit, spectroscopic characteristics of light that is reflected from the ingredient; and analyzing, by a control unit, the spectroscopic characteristics; determining, by the control unit, a cooking state of the ingredient; and controlling, by the control unit, the driving unit based on the determined cooking state to cook the ingredient.

In an embodiment, the selectively positioning of the grill may further include: rotating the grill 180 degrees; and moving the grill up or down in a vertical direction.

In an embodiment, the grill may be moved up to an upper cooking area to perform an additional cooking process.

In an embodiment, the method may further include: determining, by the control unit, when cooking is completed based on at least the cooking state of the ingredient.

In an embodiment, the grill may be moved to a standby area when cooking is completed.

### BRIEF DESCRIPTION OF THE DRAWINGS

The above and other aspects and features of the present disclosure will be more clearly understood from the following detailed description of the illustrative, non-limiting example embodiments with reference to the accompanying drawings.

FIG. 1 is a front view illustrating an automatic grilling robot according to one or more embodiments of the present disclosure.

FIG. 2 is a side view illustrating the automatic grilling robot according to one or more embodiments of the present disclosure.

FIG. 3 is a side cross-sectional view illustrating the automatic grilling robot according to one or more embodiments of the present disclosure.

FIG. 4 is a side cross-sectional view illustrating a driving unit of the automatic grilling robot according to one or more embodiments of the present disclosure.

FIG. 5 is a side cross-sectional view illustrating a state in which the driving unit of the automatic grilling robot positions a grill above a heat source according to one or more embodiments of the present disclosure.

FIG. 6 is a front view illustrating the grill positioned in an upper cooking area above the heat source by the driving unit of the automatic grilling robot according to one or more embodiments of the present disclosure.

FIG. 7 is a side cross-sectional view illustrating a state in which the grill is moved upward by the driving unit of the automatic grilling robot and positioned in a defined sensing area located below a sensing unit according to one or more embodiments of the present disclosure.

FIG. 8 is a front cross-sectional view illustrating the state in which the grill is raised by the driving unit of the automatic grilling robot and positioned in the defined sensing area located below the sensing unit according to one or more embodiments of the present disclosure.

FIG. 9 is a side cross-sectional view illustrating a state in which the driving unit of the automatic grilling robot moves the grill downward from the sensing area according to one or more embodiments of the present disclosure.

FIG. 10 is a side cross-sectional view illustrating a state in which the driving unit of the automatic grilling robot rotates the grill by 180 degrees according to one or more embodiments of the present disclosure.

FIG. 11 is a side cross-sectional view illustrating a state in which the grill, after rotated 180 degrees by the driving unit of the automatic grilling robot, is positioned in the upper cooking area of the heat source according to one or more embodiments of the present disclosure.

FIG. 12 is a block diagram illustrating an interconnection of components within the automatic grilling robot according to one or more embodiments of the present disclosure.

FIG. 13 is a side cross-sectional view illustrating a heat sensing unit applied to the automatic grilling robot according to one or more embodiments of the present disclosure.

FIG. 14 is a side view illustrating a first coupling member and a second coupling member that are applied to the automatic grilling robot according to one or more embodiments of the present disclosure.

<Description of Reference Numerals>

| | |
|---|---|
| 10: Heat source | 20: Grill |
| 21: Lower frame | 22: Upper frame |
| 100: Body | 110: Screen |
| 111: Installation space | 120: Wheels |
| 130: Exhaust port | 200: Driving unit |
| 210: First housing | 220: Link member |
| 230: First operation motor | 240: Second housing |
| 250: Second operation motor | 300: Sensing unit |
| 310: Light emitting member | 320: Light receiving member |
| 400: Control unit | 500: Ventilation unit |
| 510: Ventilation motor | 520: Ventilation fan |
| 600: Blowing unit | 610: Blowing unit motor |
| 620: Blowing Fan | 700: Heat Sensing Unit |
| 800: Notification unit | 910: First coupling member |
| 920: Second Coupling Member | |
| F: Ingredient | L: Light |

### DETAILED DESCRIPTION

Hereinafter, embodiments of the present disclosure will be described in detail with reference to the accompanying drawings, in which like reference numbers refer to like elements throughout. In the drawings, the relative sizes of elements, members, parts, and regions and the thickness of the lines may be exaggerated and/or simplified for clarity.

Certain advantages and features of one or more embodiments of the present disclosure and one or more methods of achieving the same will become apparent with reference to embodiments described below in detail with reference to the accompanying drawings.

Embodiments will be described in more detail with reference to the accompanying drawings, in which like reference numbers refer to like elements throughout. The present disclosure, however, may be embodied in various different forms, and should not be construed as being limited to only the illustrated embodiments herein. Rather, these embodiments are provided as examples so that this disclosure will be thorough and complete, and will fully convey the aspects and features of the present disclosure to those skilled in the art. Accordingly, processes, elements, and techniques that are not necessary to those having ordinary skill in the art for a complete understanding of the aspects and features of the present disclosure may not be described. Unless otherwise noted, like reference numerals denote like elements throughout the attached drawings and the written description, and thus, redundant description thereof may not be repeated

It will be understood that when one component, member, or part is described as “including” or “includes” another component, member, or part, it shall not be limitedly construed as consisting of only that one component, member, or part unless otherwise stated, and shall be understood that other components, members, or part may be further included.

It will be understood that when an element, member, part, or feature is referred to as being “on,” “connected to,” or “coupled to” another element, member, part, or feature, it can be directly on, connected to, or coupled to the other element, member, part, or feature, or one or more intervening elements, members, parts, or features may be present.

The terms “upper,” “lower,” “bottom,” “front side,” “rear side,” “below,” etc., used herein are merely for facilitating explanation and indicating the orientation of a component as illustrated in the drawings.

The objective of one or more embodiments of the present disclosure is to provide an automatic grilling robot capable of detecting a cooking state of ingredients and thereby achieving consistent, high-quality cooking results equivalent to those of professional chefs.

According to one or more embodiments of the present disclosure, the cooking state of one or more ingredients may be monitored in real time to ensure uniform cooking quality. Spectroscopic analysis may enable detection of molecular property changes, allowing optimal cooking recipes to be applied.

One or more embodiments of the present disclosure further prevent foreign substances from contaminating a sensing unit, maintain optimal sensor accuracy by shielding external light, and reduce a user's fatigue by eliminating the need for repeated manual inspections.

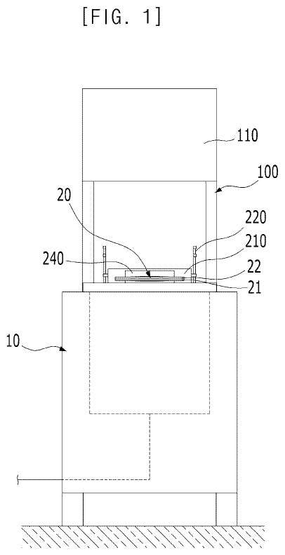

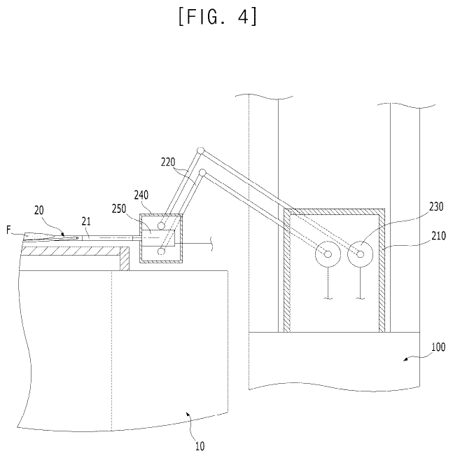

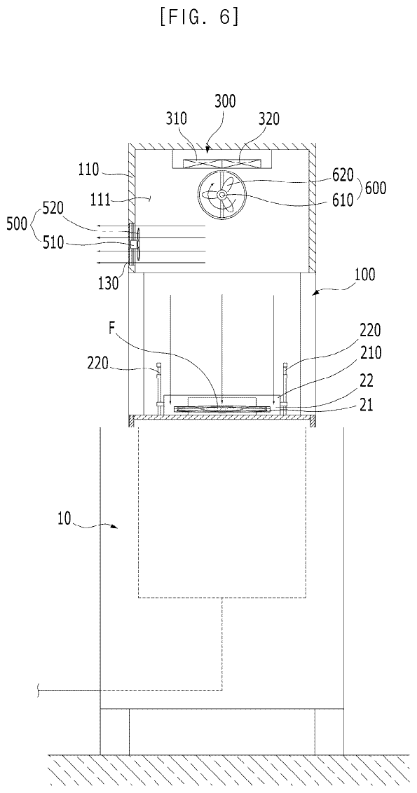

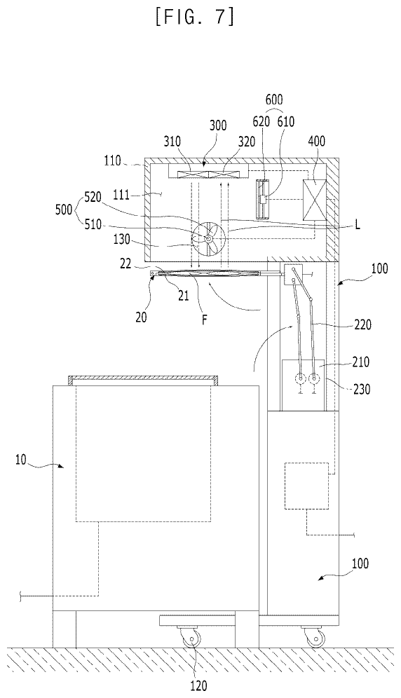

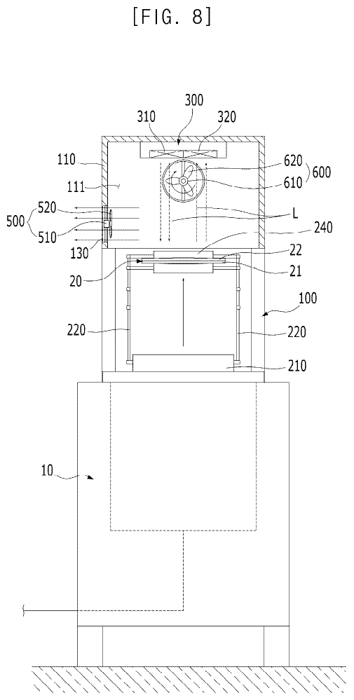

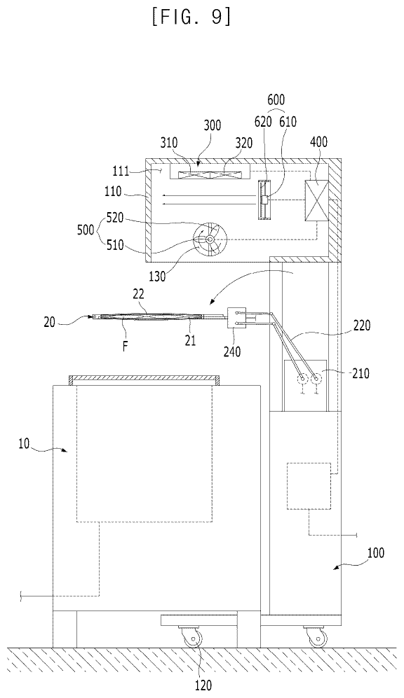

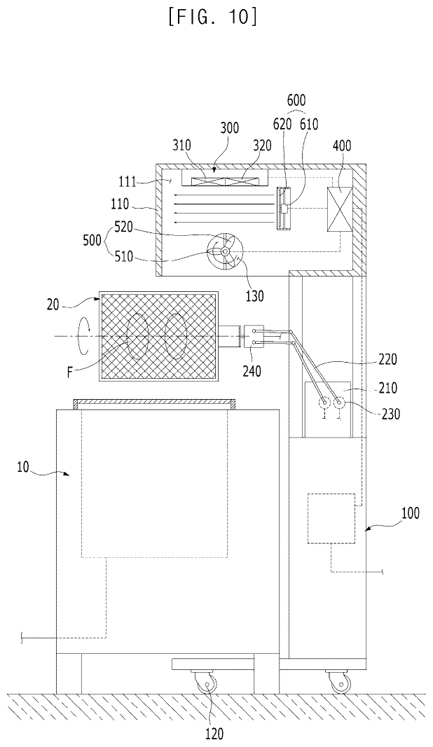

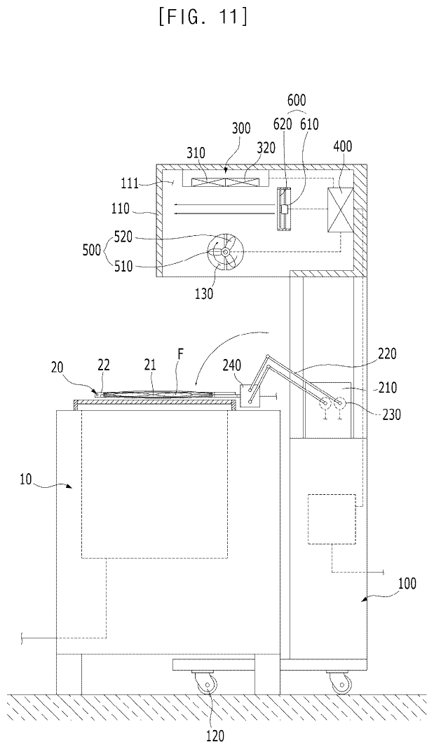

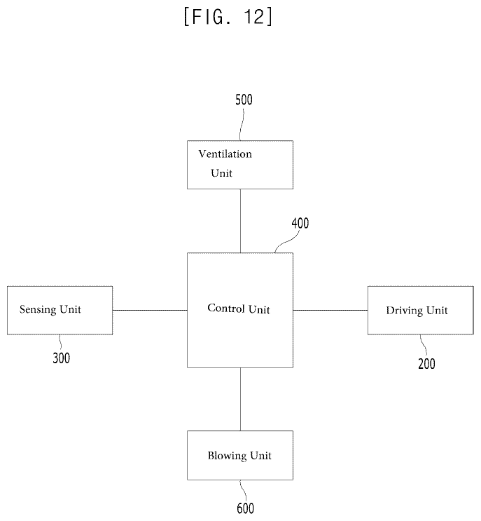

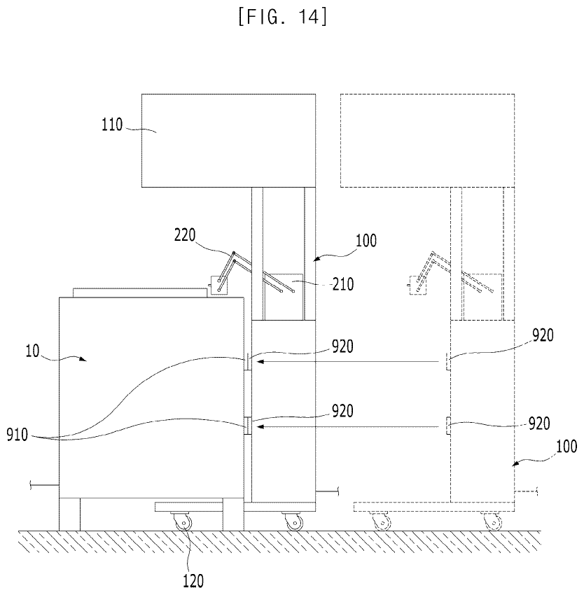

Referring to FIGS. 1 to 14, according to one or more embodiments of the present disclosure, an automatic grilling robot is configured to automatically cook a grill in which one or more ingredients may be placed while the grill is moving and rotating. In one embodiment, the automatic grilling robot may include a main body 100, a driving unit 200, a sensing unit 300, and a control unit 400.

In an embodiment, the main body 100 may be positioned at one side of a heat source 10 that is configured to generate heat by burning fuel (e.g., gas, etc.). A driving unit 200 (more fully described below) may be located at an upper portion of the heat source 10. A control unit 400 (more fully described below) may be located in the main body 100.

In an embodiment, the automatic grilling robot may further include a screen 110 mounted on an upper portion of the main body 100, the screen 110 having an installation space 111 that is open downward. The screen 110 may be mounted on the upper portion of the main body 100 via a separate support structure and positioned above the driving unit 200. In this embodiment, a lower end of the support structure may be connected to the top of the main body 100, and an upper end of the support structure may be connected to the screen 110.

In an embodiment, a front surface of the screen 110 may protrude further to the front of the main body 100, and a lower portion of the installation space 111 may be opened downward from the front of the main body 100. The sensing unit 300 (more fully described below) may be configured to irradiate or emit light L in the installation space 111 toward a sensing area, which is located below the sensing unit 300.

In an embodiment, a plurality of rotatable wheels 120 may be provided at a lower portion of the main body 100. The wheels 120 may be configured to rotate based on a horizontal rotation center formed at a lower end of a bracket, and an upper end of the bracket may be coupled to a lower surface of the main body 100.

In an embodiment, the driving unit 200 may be configured to move the grill 20 in which a food ingredient F is placed to a cooking area CA located above the heat source 10, a sensing area MA located below the screen 110, and a standby area AA. The driving unit 200 may be provided above the main body 100 to selectively position the grill in which the food ingredient F is placed in the cooking area CA, the sensing area MA, and the standby area AA. When the grill 20 is moved to the cooking area CA and the sensing area MA, the grill 20 may be rotated to invert the upper and lower surfaces of the food ingredient F.

The driving unit 200 may be further configured to include a first housing 210 provided at the upper portion of the main body 100; at least one link member 220, each having a rear end rotatably coupled to an inner portion of the first housing 210 through an outer portion of the first housing 210; and at least one first operation motor 230 placed in the first housing 210, having a driving shaft protruding from one side of the first housing 210 and mechanically connected to the link member 220 to transmit a rotational force. The driving unit 200 may further include a second housing 240 coupled to a front end of the link member 220 and rotatably coupled to a rear end of the grill 20; and a second operation motor 250 placed in the second housing 240 and mechanically connected to the rear end of the grill 20 to transmit a rotational force.

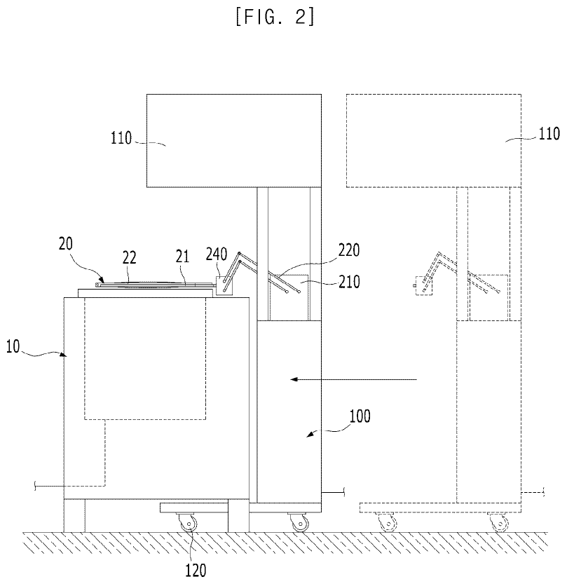

In an embodiment, a lower end of the first housing 210 may be fixedly coupled to an upper end of the main body 100. The first operation motor 230 may be installed in the first housing 210, and when the main body 100 is positioned on one side of the heat source 10 as shown in FIG. 2, a front surface of the first housing 210 may be positioned on one side of the heat source 10.

In addition, at both sides of the first housing 210, rotation shafts may be protruded forming a horizontal rotation center, respectively, and one side of the rotation shaft in an axial direction may be mechanically connected to the driving shaft of the first operation motor 230 provided in the first housing 210.

In an embodiment, the link members 220 may be coupled to both sides of the first housing 210, respectively, and the rear end of each link member 220 may be coupled to each rotating shaft protruding from each side of the first housing 210, respectively. The link member 220 may be configured to include one or more joints that are rotatably connected to each other. In this embodiment, the structure of the link member 220 may be variously applied as necessary.

In addition, the link member 220 may be applied to be movable in a left-right direction. In one embodiment, an auxiliary driving unit (not shown) for moving the link member 220 left and right may be provided in the first housing 210. The rotation shafts protruding from both sides of the first housing 210 may be moved left and right by the auxiliary driving unit. The grill 20 may be moved up and down, left and right, back and forth, or rotated.

According to one or more embodiments of the present disclosure, the link member 220 may have a length. The link member 220 may have one longitudinal side rotatably connected with respect to a horizontal center in a left-right direction. Each link member 220 may have one longitudinal side located at a rear portion of the link member 220, and each longitudinal side may be coupled to each rotating shaft protruding from both sides of the first housing 210.

In addition, the second housing 240 may be coupled to a front end of the link member 220. The front ends of the link members 220 located at the left and right sides of the second housing 240 may be coupled to both sides of the second housing 240, respectively, and the position of the second housing 240 may be changed by the rotating movement of the link members 220.

In an embodiment, the movement of the first operation motor 230 may be configured to be controlled by the control unit 400 (more fully described below). The link member 220 may be movably connected to the motor 230 when the driving shaft of the first operation motor 230 is rotated. Although not shown, a separate driving means (e.g., a winding roll, a winding motor, a cable, or the like) for rotating the link member 220 upward toward the sensing area may be further included in the first housing 210.

Both sides of the second housing 240 may be coupled to the front end of the link members 220, respectively. The second operation motor 250 may be installed in the second housing 240. A driving shaft of the second operation motor 250 provided in the second lower housing 240 may be configured to be mechanically connected to the rear end of the grill 20.

In an embodiment, a rotation shaft may protrude from a front surface of the second housing 240. The rotation shaft may be configured to be mechanically connected to the driving shaft of the second operation motor 250. The driving shaft of the second operation motor 250 may be provided in the second housing 240. The grill 20 may be rotated 180 degrees by the movement of the second operation motor 250, and the grill 20 may be turned upside down (e.g., reversed in a vertical direction).

In an embodiment, the movement of the second operation motor 250 may be configured to be controlled by the control unit 400 (more fully described below). The grill 20 may be rotated 180 degrees when the driving shaft of the second operation motor 250 is rotated. After the grill 20 is rotated 180 degrees, the grill 20 may be moved downward toward an upper cooking area of the heat source 10 or may be moved to a lower sensing area of the screen 110.

In an embodiment, the grill 20 may include a lower frame 21 and an upper frame 22. The grill 20 may be formed as a frame having a center hole. A metal mesh net may be provided in the hole. The rear end of the grill 20 may be coupled to a rotation shaft protruding toward the front of the second housing 240. The upper frame 22 may be configured to be closely attached to an upper portion of the lower frame 21 to be opened and closed. The upper frame 22 may also be formed as a frame having a center hole, and a metal mesh net may be provided in the hole.

In addition, the lower frame 21 and a front end of the upper frame 22 may be rotatably connected to each other by a hinge forming a horizontal rotation center in a left-right direction. The lower frame 21 and the rear end of the upper frame 22 may be locked or unlocked via a locking structure. A user may lock or unlock the rear ends of the lower frame 21 and the upper frame 22 using the locking structure.

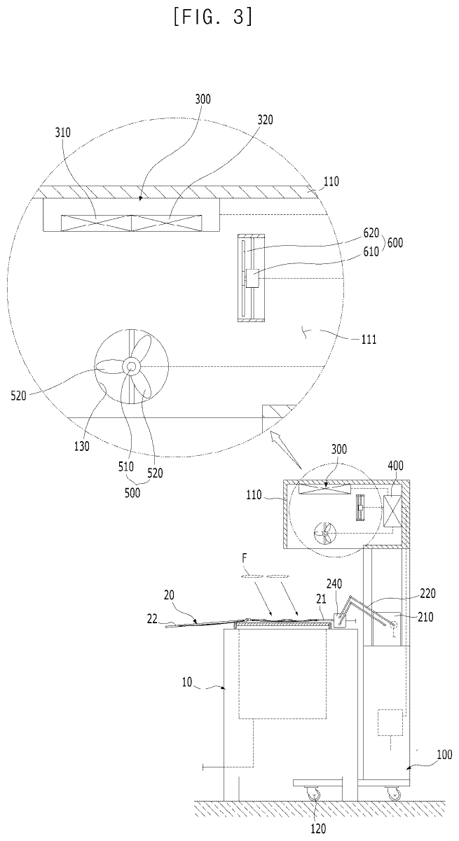

As shown in FIG. 3, the ingredient F may be placed on the mesh net of the lower frame 21 after the upper frame 22 is opened to be rotated forward. After the upper frame 22 is brought into close contact with an upper surface of the lower frame 21, the rear end of the upper frame 22 and a rear end of the lower frame 21 may be coupled to each other. In this embodiment, ingredients (e.g., the ingredient F, meat, etc.) may be held and fixed between the lower frame 21 and the upper frame 22.

In an embodiment, the sensing unit 300 may be provided at the upper portion of the main body 100 to be positioned above the driving unit 200. The sensing unit 300 may be configured to irradiate or emit light L toward the sensing area located below the sensing unit and to detect spectral characteristics of the light L reflected from the ingredient F. In this embodiment, the sensing unit 300 may be provided in the installation space 111 of the screen 110 and may be configured to irradiate or emit the light L to the sensing area.

The sensing unit 300 may include a light emitting member 310 for irradiating or emitting light L toward the ingredient F, and a light receiving member 320 for detecting spectral characteristics of the light L reflected from the ingredient F and transmitting the detected spectral characteristics to the control unit 400.

In an embodiment, the light emitting member 310 may be configured to irradiate or emit the light L to the ingredient F placed in the grill 20. The light emitting member 310 may be configured to be electrically (wired or wireless) connected to the control unit 400 for control of the operation of the light emitting member 310. In this embodiment, at least one light source installed on one side of the light emitting member 310 may be provided to irradiate or emit the light L to the sensing area. A light emitting diode (LED) may be used as the light source. The light source having any suitable form/shape may be selectively used.

In addition, the light L irradiated or emitted from the light source of the light emitting member 310 may be configured to be irradiated or emitted to a specific section of the sensing area. The area to which the light L is irradiated or emitted, the angle of the light L, illuminance of the light L, and/or the like may be variously applied according to the size and installation conditions (e.g., position and height of the light emitting member 310, or the like) of the sensing area. The light L irradiated or emitted from the light source may be irradiated or emitted to the entire or a partial area of the sensing area.

In an embodiment, the light receiving member 320 may be configured to receive the light L reflected from the ingredient F. The light receiving member 320 may be configured to be electrically (wired or wireless) connected to the control unit 400 for control of the operation of the light receiving member 320. One or more lens for receiving the light L may be installed on one side of the light receiving member 320. In this embodiment, the light receiving member 320 may be configured to selectively use a color camera, a complementary metal-oxide semiconductor (CMOS), a charge coupled device (CCD), or the like. The light receiving member 320 may be configured to utilize any suitable sensing methods.

When the light L reflected by the ingredient F is received through the lens, the light receiving member 320 may be configured to detect spectral characteristics of the received light L and transmit a sensing signal to the control unit 400 (more fully described below). At this time, the control unit 400 is configured to analyze the spectral characteristics transmitted from the light receiving member 320 to detect molecular information of the ingredient F.

In an embodiment, the control unit 400 may be configured to control the operation of the driving unit 200, analyze the spectral characteristics transmitted from the sensing unit 300, and detect the molecular characteristic state (e.g., molecular information) of the corresponding ingredient F. To do that, the control unit 400 may be configured to control the operation of the driving unit 200 based on a cooking pattern determined to be suitable for a cooking state (e.g., the detected cooking state of the ingredient F). In this embodiment, a cooking profile may be pre-selected that is suitable for cooking the ingredient F.

In this embodiment, the control unit 400 may be configured to analyze the spectral characteristics transmitted from the sensing unit 300 to detect the molecular characteristic state (e.g., moisture level/amount, protein/fat/collagen composition ratio(s), ripeness, Maillard reaction level, tissue characteristic change(s), etc.) of the ingredient F. The control unit 400 may be configured to selectively control the operation of the driving unit 200.

In addition, the control unit 400 may be installed on any suitable part in the main body 100, and the place of installation should not be limited. A power supply unit (not shown) for supplying power and a manipulation unit (not shown) may be electrically connected to the control unit 400 to enable the user to manipulate the power supply unit.

In an embodiment, the manipulation unit may include a manipulation switch (not shown) to allow the user to manipulate the control unit 400, and a display unit for displaying various types of information (e.g., cooking time, cooking intensity, molecular information, etc.). Through the displayed information on the display unit, the user may check a cooking state or the like.

In an embodiment, various types of ingredient information may be preset in the control unit 400. The ingredient information may be displayed and selected by using the manipulation unit and the display unit. The control unit 400 may display the cooking state of the ingredient F through the display unit.

According to one or more embodiments of the present disclosure, the automatic grilling robot may further include an exhaust port 130 formed at one side of the screen 110 to connect the installation space 111 with outside air; a ventilation unit 500 installed on the screen 110 to forcibly discharge internal air in the installation space 111 to outside through the exhaust port 130; and a blowing unit 600 provided in the installation space 111 that is configured to blow air horizontally from a lower portion of the sensing unit 300.

In an embodiment, the ventilation unit 500 may include a ventilation motor 510 installed on a side wall of the installation space 111 and having an on/off state controlled by the control unit 400, and a ventilation fan 520 coupled to a driving shaft of the ventilation motor 510 and having a plurality of wings in a radial direction. The ventilation fan 520 is configured to forcibly exhaust the air in the installation space 111 to outside through an exhaust mechanism 130 by the rotational movement of the ventilation fan 520.

When smoke is introduced into the lower portion of the installation space 111 during cooking, smoke and oil vapor stuck in the installation space 111 may be forcibly exhausted to outside while the ventilation fan 520 is being rotated. Thus, any potential sensing errors that may be caused by smoke and oil vapor may be prevented.

In an embodiment, the blowing unit 600 may include a blowing unit motor 610 installed in the installation space 111 and having an on/off state controlled by the control unit 400, and a blowing fan 620 coupled to a driving shaft of the blowing unit motor 610 and having a plurality of wings in a radial direction. The blowing fan 620 may be configured to form an air curtain at the lower portion of the sensing unit 300 by horizontally blowing air in the installation space 111 by the rotational movement of the blowing fan 620.

Because the air blowing unit 600 forms the air curtain below the sensing unit 300 during cooking, it prevents oil vapor and similar contaminants from adhering to the lens of the sensing unit 300. As a result, the accuracy of the sensing unit 300's measurement is maintained by preventing lens contamination, and any taste deviation of cooked food ingredient F may be reduced due to consistent and accurate measurement of the sensing unit 300.

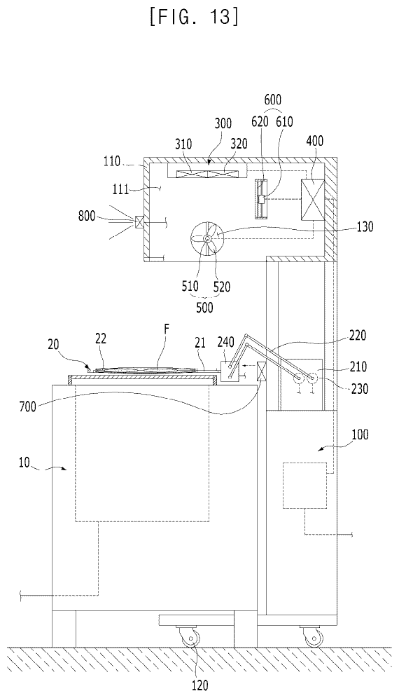

As shown FIG. 13, according to one or more embodiments of the present disclosure, the automatic grilling robot may further include a heat sensing unit 700 installed in either the heat source 10 or the screen 110. The heat sensing unit 700 may be configured to sense/detect heat generated by the heat source 10 in real time and transmit a heat sensing signal to the control unit 400. The automatic grilling robot may further include a notification unit 800 configured to be electrically connected to the control unit 400 and configured to output sound, light, or both when the notification unit 800 is activated (e.g., turned on).

In an embodiment, the heat sensing unit 700 may be configured to use a sensor for sensing heat. The control unit 400 may be configured to adjust a cooking level of the ingredient by changing the cooking pattern through use of heat sensing data (e.g., the heat sensing signal) transmitted from the heat sensing unit 700.

The operation of the automatic grilling robot according to one or more embodiments of the present disclosure will be described with reference to FIGS. 3 to 11.

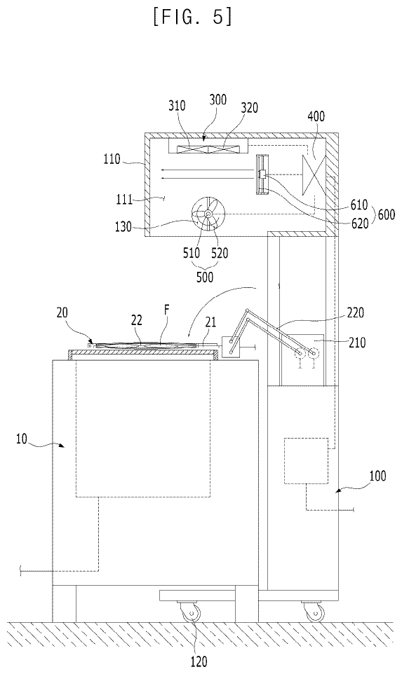

First, as shown in FIG. 3, one or more ingredients (e.g., F, meat, etc.) are fixedly placed inside of the grill 20. As shown in FIG. 5, next, the heat source 10 and the automatic grilling robot are operated. At this time, one or more link members 220 of the driving unit 200 may be rotated to position the grill 20 in the upper cooking area of the heat source 10.

After a set time elapsed, one or more link members 220 are rotated to move upward the grill 20 to a pre-determined height, and then the grill 20 may be rotated 180 degrees by the operation of the second operation motor 250. Next, while the link members 220 are being rotated, the grill 20 whose upper and lower positions are vertically reversed may be positioned in the sensing area.

Next, the sensing unit 300 may detect the spectral characteristics of the light L reflected in the ingredient F after irradiating or emitting light to the sensing area. The control unit 400 may detect a cooking state of the ingredient F by analyzing the spectral characteristics transmitted from the sensing unit 300. The control unit 400 may operate the driving unit 200 with a cooking pattern that matches the detected cooking state of the ingredient F.

After the cooking state of the ingredient F located in the sensing area is measured or detected, the grill 20 may be moved back to the upper cooking area of the heat source 10 to perform an additional cooking process. The grill 20 may also be moved between the cooking area and the sensing area once or more, according to the cooking state of the ingredient F to complete the cooking process. When cooking is completed, the link members 220 may be rotated rearward to position the grill 20 in a standby area. Next, a cook/user may open the grill 20 to separate the food ingredient F from the grill 20.

As a result, the automatic grilling robot described in the present disclosure is capable of uniformly maintaining high cooking quality by checking a cooking state of ingredients during cooking. The automatic grilling robot can analyze a change in the molecular properties of the ingredient in real time through a spectroscopic analysis during cooking, thereby, the robot is able to cook the ingredient F with an optimal recipe.

In addition, according to one or more embodiments of the present disclosure, it is possible to maintain the automatic grilling robot's performance of analyzing the ingredient F in an optimal state through the described structure that prevents foreign substances from adhering to the sensing unit 300 during cooking and blocks external light during the sensing process. It is also possible to reduce fatigue of a human cook/user during cooking because a cooking state of the ingredient F does not need to be repeatedly checked by the human cook/user.

While one or more embodiments of the automatic grilling robot and related devices and/or components are described herein, it should be noted that those embodiments may be modified without departing from the spirit and scope of the present disclosure.

The electronic or electric devices and/or any other relevant devices or components according to embodiments of the present disclosure described herein (e.g., the control unit, the ventilation unit, the sensing unit, the driving unit, the blowing unit, etc.) may be implemented utilizing any suitable hardware, firmware (e.g. an application-specific integrated circuit), software, or a combination of software, firmware, and hardware. For example, the various components of these devices may be formed on one integrated circuit (IC) chip or on separate IC chips. Further, the various components of these devices may be implemented on a flexible printed circuit film, a tape carrier package (TCP), a printed circuit board (PCB), or formed on one substrate. Further, the various components of these devices may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the spirit and scope of the example embodiments of the present disclosure.

The foregoing is illustrative of some embodiments of the present disclosure and is not to be construed as limiting thereof. Although some embodiments have been described, those skilled in the art will readily appreciate that various modifications are possible in the embodiments without departing from the spirit and scope of the present disclosure. It will be understood that descriptions of features or aspects within each embodiment should typically be considered as available for other similar features or aspects in other embodiments, unless otherwise described. Thus, as would be apparent to one of ordinary skill in the art, features, characteristics, and/or elements described in connection with a particular embodiment may be used singly or in combination with features, characteristics, and/or elements described in connection with other embodiments unless otherwise specifically indicated. Therefore, it is to be understood that the foregoing is illustrative of various example embodiments and is not to be construed as limited to the specific embodiments disclosed herein, and that various modifications to the disclosed embodiments, as well as other example embodiments, are intended to be included within the spirit and scope of the present disclosure as defined in the appended claims, and their equivalents.

1. An automatic grilling robot comprising:
a heat source configured to generate heat;
a driving unit configured to selectively position a grill on top of the heat source, the grill containing an ingredient;
a sensing unit configured to emit light to the ingredient and detect spectroscopic characteristics of light that is reflected from the ingredient; and
a control unit configured to determine a cooking state of the ingredient based on the detected spectroscopic characteristics and control the driving unit based on the determined cooking state.

2. The automatic grilling robot of claim 1, wherein the driving unit is further configured to rotate the grill to invert the ingredient.

3. The automatic grilling robot according to claim 1, wherein the driving unit comprises:
a first housing;
at least one link member comprising a rear end rotatably coupled to the first housing; and
at least one first operating motor comprising a first drive shaft protruding from the first housing, the first drive shaft being mechanically connected to the at least one link member to transmit a rotational force.

4. The automatic grilling robot according to claim 3, wherein the driving unit further comprises:
a second housing coupled to a front end of the link member, the second housing comprising a front end to which a rear end of the grill is rotatably coupled; and
a second operating motor comprising a second drive shaft protruding from the second housing, the second drive shaft being mechanically connected to the rear end of the grill to transmit a rotational force.

5. The automatic grilling robot of claim 1, further comprising: a screen having an installation space that is open downward, wherein the sensing unit is provided in the installation space and configured to emit light downward.

6. The automatic grilling robot of claim 5, further comprising:
an exhaust port formed at one side of the screen to define a ventilation path between the installation space and an outer area; and
a ventilation unit placed in the screen to discharge internal air in the screen from the installation space to the outer area through the exhaust port.

7. The automatic grilling robot of claim 1, wherein the control unit is configured to analyze the spectroscopic characteristics to determine the cooking state of the ingredient.

8. The automatic grilling robot of claim 7, wherein molecular information of the ingredient is detected based on the spectroscopic characteristics, wherein the molecular information is used by the control unit to control the driving unit.

9. The automatic grilling robot of claim 8, wherein the molecular information comprises at least one of a moisture amount, a protein/fact/collagen composition ratio, ripeness, a Maillard reaction level, or a tissue-characteristic change of the food ingredient.

10. The automatic grilling robot of claim 1, wherein the control unit is further configured to operate the driving unit with a cooking pattern that matches with the detected cooking state of the ingredient.

11. An automatic grilling robot comprising:
a driving unit configured to selectively position a grill on top of a heat source, the grill containing an ingredient;
a control unit configured to determine a cooking state of the ingredient and control the driving unit to cook the ingredient based on the determined cooking state;
a manipulation unit electrically connected to the control unit, the manipulation unit configured to allow a user to operate the control unit to cook the ingredient; and
a display unit configured to display various types of information about cooking of the ingredient.

12. The automatic grilling robot of claim 11, wherein the various types of information comprises at least one of a cooking time, a cooking intensity, or molecular information of the ingredient.

13. The automatic grilling robot of claim 11, wherein the control unit is further configured to display the cooking state of the ingredient to the user.

14. The automatic grilling robot of claim 11, wherein the driving unit is further configured to rotate the grill to invert the ingredient.

15. The automatic grilling robot of claim 11, wherein the driving unit is further configured to move the grill up or down in a vertical direction.

16. A method of automatically cooking an ingredient comprising:
generating, by a heat source, heat;
selectively positioning, by a driving unit, a grill on top of the heat source, the grill containing the ingredient;
emitting, by a sensing unit, light to the ingredient;
detecting, by the sensing unit, spectroscopic characteristics of light that is reflected from the ingredient;
determining, by the control unit, a cooking state of the ingredient; and
controlling, by the control unit, the driving unit based on the determined cooking state to cook the ingredient.

17. The method of automatically cooking the ingredient of claim 16, wherein the selectively positioning of the grill further comprises:
rotating the grill 180 degrees; and
moving the grill up or down in a vertical direction.

18. The method of automatically cooking the ingredient of claim 17, wherein the grill is moved up to an upper cooking area to perform an additional cooking process.

19. The method of automatically cooking the ingredient of claim 16, further comprising: determining, by the control unit, when cooking is completed based on at least the cooking state of the ingredient.

20. The method of automatically cooking the ingredient of claim 19, wherein the grill is moved to a standby area when cooking is completed.
